(19) United States
(12) Patent Application Publication
(10) Pub. No.: US 2012/0030311 A1
(43) Pub. Date: Feb. 2, 2012

(54) System and method for inventory data extraction

(76) Inventors: Khaled Refai, Ottawa (CA); Florin Silviu Putinica, Ottawa (CA); Francis Ouaton, Ottawa (CA); Julien Kirsch, Ottawa (CA); Robert De Vlugt, Carp (CA)

(21) Appl. No.: 12/805,401

(22) Filed: Jul. 29, 2010

(51) Int. Cl. G06F 15/16

(52) U.S. Cl. 709/219

(57) ABSTRACT

The present invention relates to a system and method for inventory data extraction. The system includes a client configured to transmit inventory data extraction requests, at least one server configured to collect inventory data on a node-by-node basis in response to the inventory data extraction requests, a service gateway configured to enable communication between the client and the server to allow the inventory data to be extracted. The service gateway includes a client adapter configured to translate messages including the inventory data extraction request between the client and the service gateway, a processing engine configured to map the messages to a model of the server or the client, a server adapter configured to translate the messages between the server and the service gateway.

### BACKGROUND

Data extraction is the act or process of retrieving data out of data sources for further data processing or data storage (data migration). For example, a client may request that at least one server collect inventory data according to an inventory data extraction request. Conventional methods of inventory extraction transfer contents of the database directly into a comma-separated values (CSV) file. However, these methods may be relatively slow and do not take into account client/server pairs that operate according to different network protocols.

### SUMMARY

The present invention relates to a system and method for inventory data extraction.

The system includes a client configured to transmit inventory data extraction requests, at least one server configured to collect inventory data on a node-by-node basis in response to the inventory data extraction requests, a service gateway configured to enable communication between the client and the server to allow the inventory data to be extracted. The service gateway includes a client adapter configured to translate messages including the inventory data extraction request between the client and the service gateway, a processing engine configured to map the messages to a model of the server or the client, a server adapter configured to translate the messages between the server and the service gateway. The inventory extraction requests include a plurality of requests representing at least one set of threads.

The service gateway filters and reorders attributes of the collected inventory data in response to each thread based on a configuration file. Also, the service gateway writes the collected inventory data node-by-node to a plurality of output node files, where the collected inventory data for each node is written to a corresponding output node file after the inventory data is collected for each node.

The system further includes a concatenator configured to consolidate the plurality of output node files into a master output node file.

Also, the server receives a request to obtained a list of nodes that are in a database of the server from the client and generates the list of nodes in response to the request, and the server collects the inventory data node-by-node for each node within the list of nodes in response to separate inventory data extraction requests from the client. The client checks a status of the inventory extraction operation after collection of all nodes is complete.

The client adapter includes a connector to provide a connection between the client and the service gateway, and a translator to translate between a physical model of the client and a physical model of the service gateway. The server adapter includes a connector to provide a connection between the server and the service gateway and a translator to translate between a physical model of the server and the physical model of the service gateway.

The processing engine includes a generic physical model to implement both a logical model of the client and a logical model of the server, and the generic physical model defines a mapping between the logical model of the client and the logical model of the server. Also, the service gateway may include a processing engine and at least one processing engine extension processor, where the processing engine manages the at least one processing engine extension processor.

The method includes collecting, by at least one server, inventory data on a node-by-node basis in response to inventory data extraction requests from a client, and communicating, via a service gateway, messages including the inventory data extraction request. The communicating step further includes translating, by a client adapter, the messages between the client and a service gateway, mapping, by a processing engine, the messages to a model of the client or the server, and translating, by a server adapter, the messages between the server and the service gateway. The inventory extraction requests include a plurality of requests representing at least one set of threads.

The method further includes filtering and reordering, by the service gateway, attributes of the collected inventory data in response to each thread based on a configuration file, and writing, by the service gateway, the collected inventory data to a plurality of output node files, where the collected inventory data for each node is written to a corresponding output node file after the inventory data is collected for each node. The method further includes transferring, by the service gateway, the plurality of output node files to be consolidated into a master output node file.

The method further includes receiving, by the server, a request to obtained a list of nodes that are in a database of the server, and generating, by the server, the list of nodes in response to the request from the client, where the collecting step collects the inventory data node-by-node for each node within the list of nodes in response to separate inventory data extraction requests from the client.

The method further includes checking, by the client, a status of the inventory data extraction operation after collection of all nodes is complete.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the present invention, and wherein:

FIG. 1 illustrates a system for inventory data extraction according to embodiments of the present invention;

FIG. 2 illustrates a diagram for handling a client request in the system of FIG. 1 according to embodiments of the present invention;

FIG. 3 is a diagram illustrating the process of handling a request by the service gateway according to embodiments of the present invention;

FIG. 4 is a diagram illustrating the process of handling a request by the service gateway engine for accessing multiple servers according to embodiments of the present invention;

FIG. 5 is a diagram illustrating the processing of handling a server event or notification by the service gateway according to embodiments of the present invention;

FIG. 6 illustrates a system involving multiple processing engines according to embodiments of the present invention; and

FIG. 7 illustrates a method of inventory data extraction utilizing the system in FIGS. 1-6 according to embodiments of the present invention.

### DETAILED DESCRIPTION OF EXAMPLE EMBODIMENTS

Various embodiments of the present invention will now be described more fully with reference to the accompanying drawings. Like elements on the drawings are labeled by like reference numerals.

As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The present invention will now be described with reference to the attached figures. Various structures, systems and devices are schematically depicted in the drawings for purposes of explanation only and so as not to obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. To the extent that a term or phrase is intended to have a special meaning, i.e., a meaning other than that understood by skilled artisans, such a special definition will be expressly set forth in the specification that directly and unequivocally provides the special definition for the term or phrase.

Embodiments of the present invention provide a service gateway that is connected between at least one client and at least one server. The service gateway allows communication between client-server pairs, which may operate according to different protocols. The service gateway, among other components, includes a processing engine configured to map messages (e.g., requests and responses) to a model of a client or server. For instance, the processing engine maps one model (client) to another model (server) or vice versa. An extraction mechanism utilizes the service gateway to collect inventory data for the client on a node-by-node basis.

First, the present disclosure will discuss the architecture of the service gateway. Next, the present disclosure will discuss the extraction mechanism that utilizes the service gateway to extract inventory data.

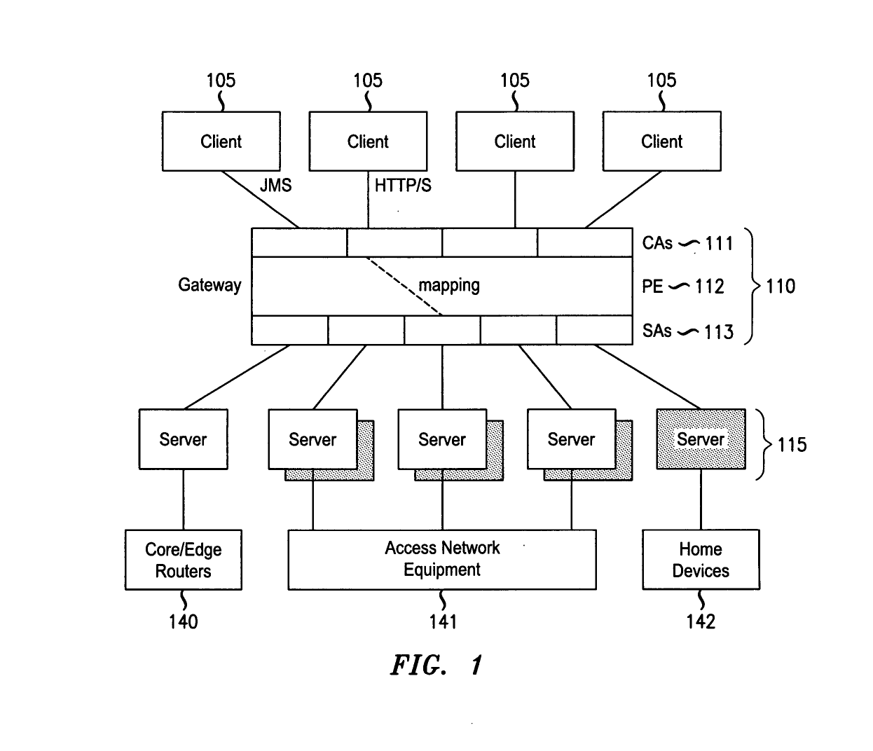

FIG. 1 illustrates a system for inventory data extraction according to embodiments of the present invention. The system includes at least one client 105 and at least one server 115 connected to at least one service gateway 110. The server 115 may be any application such an Element Management System (EMS) or Network Management System (NMS) application, for example, which exposes a programmatic networking management interface. The EMS or NMS application operates on at least one computer processing unit that includes at least one processor and memory such as Read Only Memory (ROM) or Random-access memory (RAM). For example, the EMS or NMS application may operate on one computer processing unit or multiple computer processing units. However, for purposes of this disclosure, each server 115 refers to the EMS or NMS application as well as the underlying hardware of the computer processing unit. Each server 115 also includes internal systems to carry out network management functionalities such as network configurations, inventory, fault management, performance management, etc. A server 115 may be connected to at least one core-edge router 140, an access network equipment 141, and at least one home device 142.

The client 105 may be any type of application that requires access to one or more of the servers 115, but may not implement the interfaces they are exposing and/or the communication protocols they are using. For example, the client 105 may be an OSS client that implements a Multi-Technology Operations System Interface (MTOSI) standard. Also, each client 105 includes programming logic to connect to a Business Support System (BSS) to carry out and store instructions according to the client application. The application operates on a computer processing unit that includes at least one processor and memory such ROM or RAM. Therefore, for purposes of this disclosure, each client 105 refers to the application as well as the underlying hardware of the computer processing unit.

For each client/server pair, the service gateway 110 is configured to handle the client and server communication protocols and to define a specific mapping between a networking model of the client 105 and a networking model of the server 115, as explained later in the specification.

The service gateway 110 includes at least one client adapter (CA) 111, at least one processing engine (PE) 112, and at least one server adapter (SA) 113. For instance, for each type of a client 105 that is connected to the service gateway 110, a client adapter 111 is provided. Also, for each type of a server 115 connected to the service gateway 110, a server adapter 113 is provided. The processing engine 112 defines a mapping for each client adapter/server adapter in the service gateway 110. The service gateway 110 also is implemented in a computer processing unit that may be included in the computer processing unit of the server 115, or implemented in a separate computer processing unit. In addition, the functionality of the service gateway 110 may be implemented in a cluster of computer processing units for operating multiple service gateways 110.

The client adapter 111 handles communication between the client 105 and the service gateway 110, the processing engine 112 defines mappings between networking models of the different client/server pairs, and the server adapter 113 handles communication between the service gateway 110 and server 115. The client adapter 111 and the server adapter 113 are independent from each other. For example, the client adapter 111 may be used to send requests to any server 115. Likewise, the server adapter 113 may be used irrespective of the type of client 105 connected to the service gateway 110.

An application (either the client 105 or the server 115) defines both a logical model and a physical model. The logical model is a collection of entities and relationships that describe the problem solved by the application. The physical model is an implementation of the logical model in the programming language used for the application. For any logical model, there may be many physical models. For example, a dictionary (e.g., a set of key-value pairs) may be implemented in several ways.

The purpose of the service gateway 110 is to provide a mapping from the logical and physical models of the client 105 to the logical and physical model of the server 115 (and vice versa). The service gateway 110 defines a neutral or generic physical model that is used to implement both the logical models of the client 105 and the server 115. The physical model of the service gateway 110 is designed to abstract the mapping between two different logical models in order to define generic mapping rules that can be implemented by the service gateway irrespective of the client 105 and server 115 model representations.

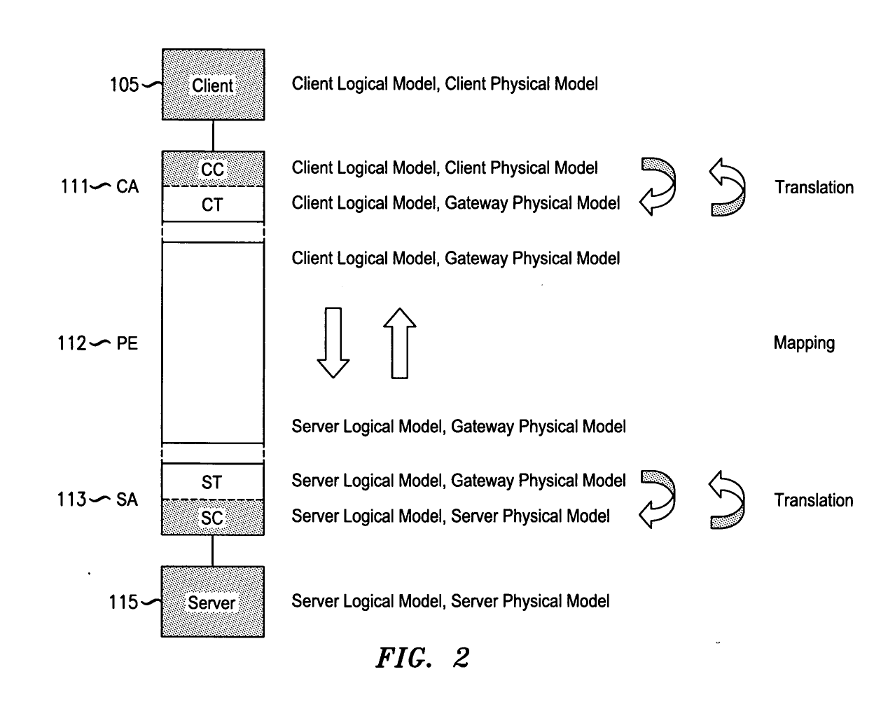

FIG. 2 illustrates a diagram for handling a client request in the system of FIG. 1 according to embodiments of the present invention.

Referring to FIG. 2, each of the clients 105 and the server 115 includes at least one connector (CC or SC) and a translator (CT or ST). For example, a client connector (CC) provides a connection between the client 105 and the service gateway 110. A server connector (SC) provides a connection between the server 115 and the service gateway 110. A client translator (CT) translates the physical model of the client 105 into the physical model of the service gateway 110 (and vice versa). A server translator (ST) translates the physical model of the server 115 into the physical model of the service gateway 110 (and vice versa). However, the logical models of the server 115 and the client 105 remain unchanged during the translations.

The connectors handle the transport protocol, while the translators are mostly concerned with the application. As a result, the client adapter 111 or the server adapter 113 may be embodied with a single translator and multiple connectors. For example, a single translator would handle the translations for the client 105, but two different connectors (e.g., HTTP/S and JMS) would provide the ability to handle multiple transport protocols. In other words, the client adapter 111 or the server adapter 113 may include a single translator and two connectors. However, embodiments of the present invention cover any number of connectors in the client adapter 111 or the server adapter 113.

Separating the client and server connectors from the processing engine 112 of the service gateway 110 allows the processing engine 112 to operate independently. As a result, the service gateway 110 may reuse, for example, server connectors written for other types of clients 105 such as graphical user interface (GUI) clients, for example.

Referring to FIG. 2, the client 105 sends a request to the server 115 via the service gateway 110, which includes the client adapter 111, the processing engine 112, and the server adapter 113: As indicated earlier, each of the client 105, the service gateway 110 and the server 115 defines a logical model and a physical model.

The client adapter 111 is configured to translate messages (e.g., requests or responses) between the client 105 and the service gateway 110. For instance, when the request is received by the client adapter (CA) 111 via the connector (CC), the translator (CT) of the client adapter 111 translates the request from the physical model of the client 105 into the physical model of the service gateway 110. As a result, the request has the physical model of the service gateway 110 and the logical model of the client 105. In other words, the client's logical model is implemented using the physical model of the service gateway 110. Similarly, when receiving a request or a response from the server 115, the client adapter 111 translates the request or response from the physical model of the service gateway 110 into the physical model of the client 105.

Referring to FIG. 2, the translated request is received at the processing engine (PE) 112. The processing engine 112 maps the request from a logical model of the client 105 to a logical model of the server 115. For example, the processing engine 112 converts the request from the logical model of the client 105 into the logical model of the server 115 using the physical model of the service gateway 110 by applying predefined client/server logical model mapping rules in service gateway configuration files specific to this kind of operation.

The request is further processed by the server adapter (SA) 113. The server adapter 113 is configured to translate messages between the service gateway 110 and the server 115. For instance, the translator (ST) of the server adapter 113 translates the request from the physical model of the service gateway 110 into the physical model of the server 115. As a result, the request has the physical and logical model of the server 115. The request is further sent to the server 115 via the connector (SC) of the server adapter 113 in order for the server 115 to perform the operation requested by the request. The server adapter 113, the processing engine 112 and the client adapter 105 operate in a similar manner when processing messages from the server 115 to the client 105.

During the translations of the client adapter 111 and the server adapter 113, data may also be validated according to rules defined by the client/server logical models. Further validation may also be executed during the mapping performed by the processing engine 112. Because the translations are executed by the client adapter 111 and the server adapter 113 and the mappings are executed by the processing engine 112, the processing engine 112 does not require specific knowledge about the physical model of the client 105 or the server 115.

The translation/mapping component of service gateway 110 (e.g., the client adapter 111, the processing engine 112, and the server adapter 113) may be implemented by a processing engine framework and processing engine extensions. The processing engine framework is a completely generic model mapping framework that provides functionality and defines an extension point (e.g., a processor). The processing engine extensions are a set of processors that performs any required action. When a client request reaches the processing engine 112, the processing engine framework instantiates and prepares a number of processors (as specified in the processing engine configuration files), and then calls the processors in the appropriate order to execute their actions.

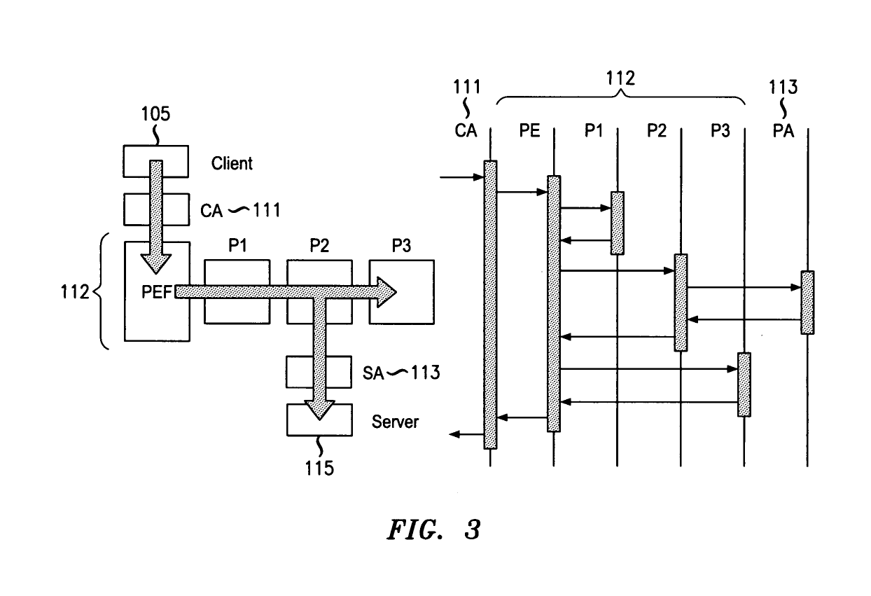

FIG. 3 is a diagram illustrating the process of handling a request by the service gateway 110 using the processing engine framework and the processing engine extensions according to embodiments of the present invention.

The client adapter 111 receives a request from the client 105, and transfers the request to the processing engine framework (PEF). The processing engine framework (PEF) prepares the processing engine extensions P1, P2, and P2, and calls them in this order according to the predefined mapping configuration rules. Next, the request is sent to processing engine extension P1, which then translates the client request into a service request. The translated client request is transferred back to the processing engine framework (PEF). Processing engine extension P2 transfers the translated client request to the server adapter 113, and receives a response back from the server adapter 113. Processing engine extension P3 translates the server response into a response that the client 105 can understand. Next, the processing engine framework (PEF) returns the response back to the client adapter 105. This completes a full synchronous operation to handle a request from the client 105 through the service gateway 110 to the server 115 and sending back the response to the client 105. During this operation, the framework is able to translate and map logical models data between the client 105 and server 115 generically based on predefined configuration files for that operation.

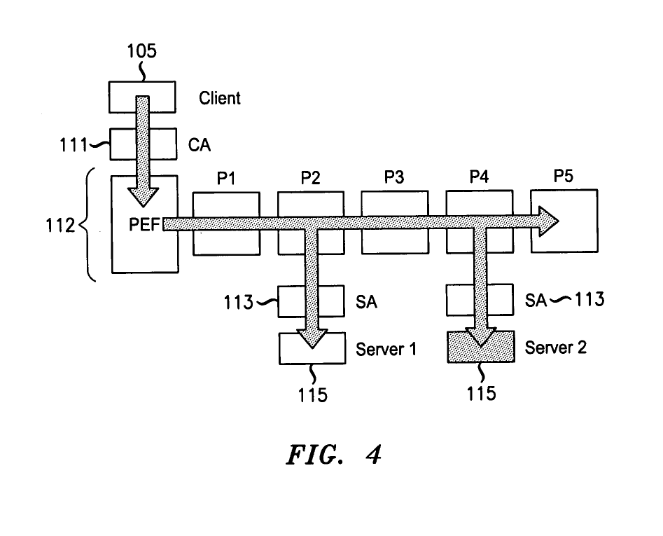

FIG. 4 is a diagram illustrating the process of handling a request by the service gateway 110 using the processing engine framework and the processing engine extensions for accessing multiple servers 115 according to embodiments of the present invention.

In this example, the operation follows the previous example illustrated in FIG. 3. However, additional steps are added (P4, P5) to collect more data from an additional server (server 2), and aggregate the results back to the client 105.

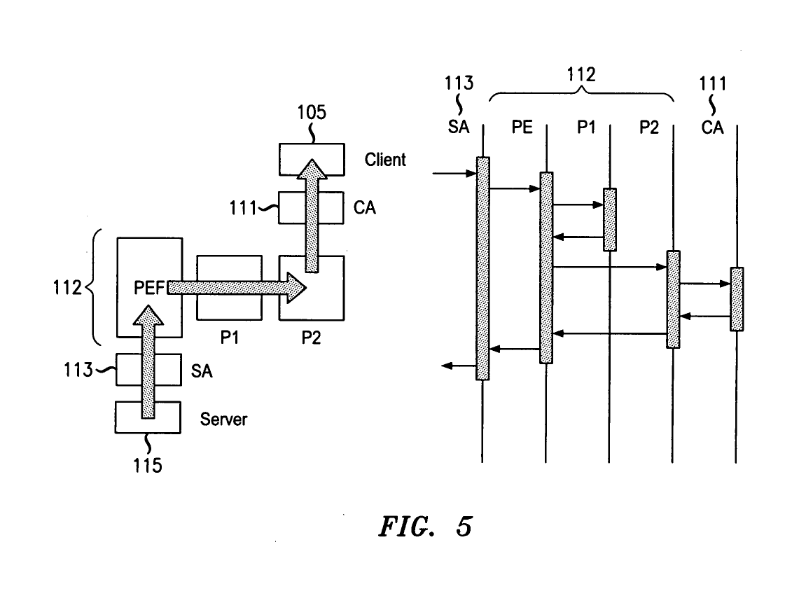

FIG. 5 is a diagram illustrating the processing of handling an asynchronous server event or notification by the service gateway 110 using the processing engine framework and the processing engine extensions according to embodiments of the present invention.

In this example, an event handler that has been registered with the server 115 to handle specific kinds of events (such as alarms, traps, or state change notifications) is called by the server 115 to trigger an event. Then, the event is translated by the server adapter 113 into the generic physical model of the service gateway 112, which will then map the logical model of the server 115 to the logical model of the client 105 according to predefined configuration rules for this specific operation. The client adapter 111 will then translate the generic physical model of the service gateway 112 to the physical model of the client 105 and send the message to the client 105 using the client's transport protocol.

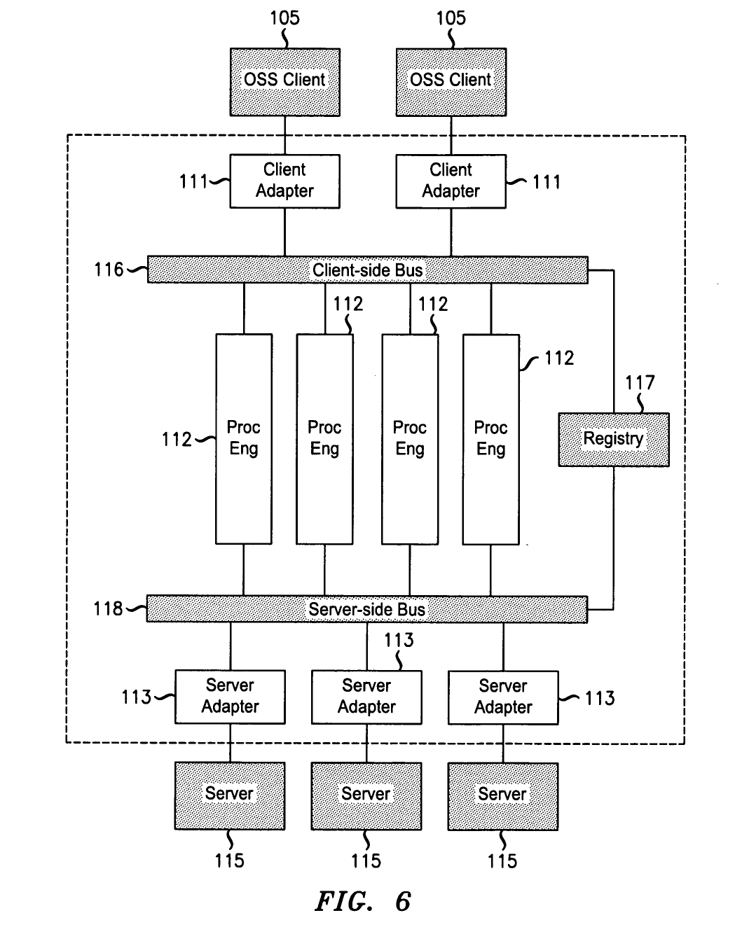

FIG. 6 illustrates a system involving multiple processing engines 112 according to embodiments of the present invention. For example, besides the main function of the service gateway (e.g., a mapping between the client model and the server model), the service gateway 110 may be required to perform other functions or services. Each one of these services is handled by a separate processing engine 112. FIG. 6 illustrates a gateway product showing four processing engines 112. However, embodiments of the present invention cover any number of processing engines 112. The four processing engines 112 of FIG. 6 may or may not operate on the same computer. Also, the client adapters 111 and the server adapters 113 may be shared between several processing engines 112, if necessary.

The system of FIG. 6 illustrates two clients 105 and three servers 115. However, example embodiments of the present invention cover any number of clients 105 and servers 115. Each of the clients 105 has a corresponding client adapter 111, which includes a connector (CC) and a translator (CT), as previously described. Because multiple processing engines 112 are used, a client-side bus 116 is connected to each of the client adapters 111 and each of the processing engines 112. Also, a server-side bus 118 is connected to each of the processing engines 112 and the server adapters 113. The client-side bus 116 and the server-side bus 118 are connected via a registry 117, which is used to provide a “lookup” functionality to identify client/server pair for predefined specific operations.

The client-side bus 116, the server-side bus 118, and the registry 117 may be referred to as an internal communication (IC) component, while the client adapter 111, the processing engine 112, and the server adapter 113 may be referred to as the translation/mapping (TM) component. If applications based on the above architecture support only a single client and server application, the IC component is not required. As such, the client-side bus 116 and the server-side bus 118 are implemented as a pass-though (e.g., a direct function call).

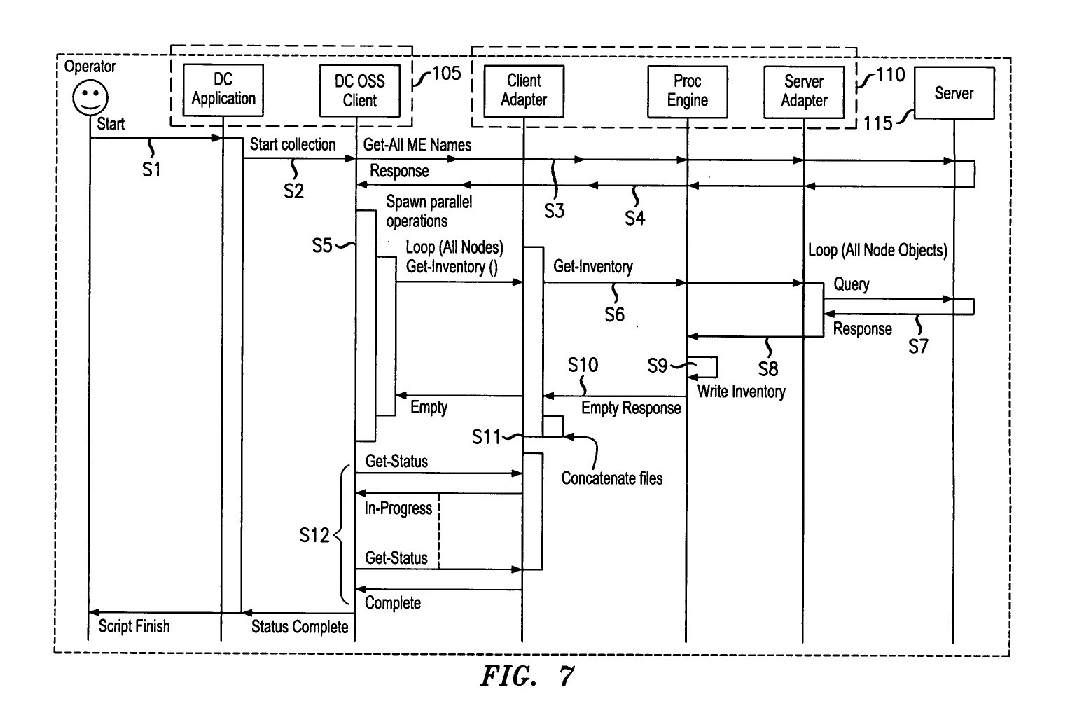

FIG. 7 illustrates a method of inventory data extraction utilizing the architecture of FIGS. 1-6 according to embodiments of the present invention.

Based on the architecture described above, the system of FIG. 1 performs an inventory data extraction method in order to extract inventory data from databases of the servers 115 when requested by the client 105. The inventory data may be Adaptable Modular Storage (AMS) data, for example. This method is realized according to a data collector script (DC-script), which is an application to transfer inventory data into a comma-separated values (CSV) file using the system built on top of the framework of FIG. 1. A format of the output CSV file is configurable through an input configuration file supplied by a user. The input configuration file specifies which node types (e.g., ISAM, GPON, G6), which objects and which attributes should be collected. Data of each object is output as a line with its attributes in columns separated by commas.

The method of FIG. 7 provides a multi-threaded inventory collection. For instance, the client 105 generates a configurable number of threads to perform multiple operations at the same time, as further described below with reference to FIG. 7.

In S1, an operator starts the DC script application. In response, in S2, the DC script prompts the client 105 to start the inventory data extraction operation.

In S3, the client 105 sends a request to the server 115 to generate a list of nodes that are in at least one database of the server 115 via the service gateway 110. For example, databases of the server 115 contain a number of nodes which contain inventory data. The service gateway 110 processes the request (and response) in a manner described above with reference to FIGS. 1-6. For example, all requests and responses (i.e., messages) sent back and forth between the client 105 and the server 115 are processed by the service gateway 110 in a manner described above with reference to FIGS. 1-6.

In S4, the server 115 transmits the list of nodes back to the client 105 via the service gateway 110.

In response, in S5, the client 105 generates inventory data extraction requests to have the server 115 collect inventory data on a node-by-node basis for each node within the list. For instance, each inventory data extraction request corresponds to one node within the list of nodes. A node-by-node basis means that one node has to be fully collected until collection of the next node begins. These inventory data extraction requests will be handled concurrently using a configurable number of parallel operations.

In S6, the client 105 sends the inventory data extraction requests, via the service gateway 110, to the server 115 to obtain inventory data for each of the nodes in the list of nodes. Inventory data will be collected for one node until that node is fully collected. For instance, each inventory data extraction request is a blocking operating that will wait until the inventory of that node is fully collected. When a node collection is finished, the thread returns, to pick up another node to collect and so forth.

In S7, the server 115 collects inventory data of one node hierarchically one layer at a time (for example, racks, shelves, slots, cards, ports, etc) and transmits this information to the service gateway 110 for further processing.

In S8, the service gateway 110 filters and reorders attributes of the collected inventory data in response to each thread based on a pre-loaded configuration file.

Then, in S9, the service gateway 110 writes the collected inventory data to a plurality of output node files. For example, after a node is collected, the service gateway 110 writes the collected inventory data for that node to one output node file. The service gateway 110 performs this operation for each node in the list. As such, the collected inventory data for each node is written to a corresponding output node file after the inventory data is collected for each node.

In S10, the service gateway 110 transfers the plurality of output node files to a concatenator, which is operating concurrently in its own thread. A concatenator may be considered a type of processor. In S11, the concatenator consolidates the plurality of output node files into a master output node file.

In S12, a process of determining when to terminate the DC script application is illustrated. For instance, in S12, the client 105 continuously checks the status of the DC script after collection of all nodes is complete and until a complete message is received by the client 105.

The DC script takes advantage of an existing generic framework to perform inventory collection with mapping, translation, and filtering capabilities. Also, by controlling data collection jobs on the client side, the DC script is able to scale individual node collections by configuring parallel collection threads, and possibly by sending collection requests to different servers in a cluster setup.

Variations of the example embodiments of the present invention are not to be regarded as a departure from the spirit and scope of the example embodiments of the invention, and all such variations as would be apparent to one skilled in the art are intended to be included within the scope of this invention.

What is claimed:

1. A system for extracting inventory data, the system comprising:
a client configured to transmit inventory data extraction requests;
at least one server configured to collect inventory data on a node-by-node basis in response to the inventory data extraction requests; and
a service gateway configured to enable communication between the client and the server to allow the inventory data to be extracted, the service gateway including,
a client adapter configured to translate messages including the inventory data extraction request between the client and the service gateway;
a processing engine configured to map the messages to a model of the server or the client; and
a server adapter configured to translate the messages between the server and the service gateway.

2. The system of claim 1, wherein the inventory extraction requests include a plurality of requests representing at least one set of threads.

3. The system of claim 2, wherein the service gateway filters and reorders attributes of the collected inventory data in response to each thread based on a configuration file.

4. The system of claim 1, wherein the service gateway writes the collected inventory data node-by-node to a plurality of output node files, the collected inventory data for each node is written to a corresponding output node file after the inventory data is collected for each node.

5. The system of claim 4, further comprising:
a concatenator configured to consolidate the plurality of output node files into a master output node file.

6. The system of claim 1, wherein the server receives a request to obtained a list of nodes that are in a database of the server from the client and generates the list of nodes in response to the request, and the server collects the inventory data node-by-node for each node within the list of nodes in response to separate inventory data extraction requests from the client.

7. The system of claim 1, wherein the client checks a status of the inventory extraction operation after collection of all nodes is complete.

8. The system of claim 1, wherein the client adapter includes:
a connector to provide a connection between the client and the service gateway; and
a translator to translate between a physical model of the client and a physical model of the service gateway.

9. The system of claim 8, wherein the server adapter includes:
a connector to provide a connection between the server and the service gateway; and
a translator to translate between a physical model of the server and the physical model of the service gateway.

10. The system of claim 1, wherein the processing engine includes a generic physical model to implement both a logical model of the client and a logical model of the server, and the generic physical model defines a mapping between the logical model of the client and the logical model of the server.

11. The system of claim 1, wherein the service gateway includes a processing engine and at least one processing engine extension processor, the processing engine managing the at least one processing engine extension processor.

12. A method for extracting inventory data, the method comprising:
collecting, by at least one server, inventory data on a node-by-node basis in response to inventory data extraction requests from a client;
communicating, via a service gateway, messages including the inventory data extraction request, the communicating step including,
translating, by a client adapter, the messages between the client and a service gateway;
mapping, by a processing engine, the messages to a model of the client or the server; and
translating, by a server adapter, the messages between the server and the service gateway.

13. The method of claim 12, wherein the inventory extraction requests include a plurality of requests representing at least one set of threads.

14. The method of claim 13, further comprising:
filtering and reordering, by the service gateway, attributes of the collected inventory data in response to each thread based on a configuration file.

15. The method of claim 12, further comprising:
writing, by the service gateway, the collected inventory data to a plurality of output node files, wherein the collected inventory data for each node is written to a corresponding output node file after the inventory data is collected for each node.

16. The method of claim 15, further comprising:
transferring, by the service gateway, the plurality of output node files to be consolidated into a master output node file.

17. The method of claim 12, further comprising:
receiving, by the server, a request to obtained a list of nodes that are in a database of the server;
generating, by the server, the list of nodes in response to the request from the client, wherein the collecting step collects the inventory data node-by-node for each node within the list of nodes in response to separate inventory data extraction requests from the client.

18. The method of claim 12, further comprising:
checking, by the client, a status of the inventory data extraction operation after collection of all nodes is complete.
